(19) United States
(12) Patent Application Publication
(10) Pub. No.: US 2019/0333048 A1
(43) Pub. Date: Oct. 31, 2019

(54) SYSTEMS AND METHODS FOR ZERO KNOWLEDGE CRYPTO-ASSET EXCHANGE

(71) Applicant: SOCIAL WALLET, INC., Anaheim, CA (US)

(72) Inventors: Ken DiCross, Los Angeles, CA (US); Luke Shepard, Burgess Hill (GB)

(21) Appl. No.: 16/396,462

(22) Filed: Apr. 26, 2019

Related U.S. Application Data
(60) Provisional application No. 62/663,827, filed on Apr. 27, 2018.

(51) Int. Cl. G06Q 20/36; G06Q 20/22; G06Q 20/06; G06Q 50/00

(52) U.S. Cl. CPC G06Q 20/363; G06Q 20/223; G06Q 2220/00; G06Q 50/01; G06Q 20/065

(57) ABSTRACT

Systems and methods for using a shared platform to transmit cryptocurrency to a zero knowledge recipient are described herein. A transferor can transmit crypto-assets to a transferee via a zero knowledge blockchain platform without having without requiring both the transferor and the transferee to have knowledge of the underlying mechanisms for enabling the transaction.

### CROSS-REFERENCE TO A RELATED APPLICATION

This application claims the benefit of U.S. Provisional Application No. 62/663,827, filed Apr. 27, 2018, the disclosure of which is incorporated herein in its entirety.

### FIELD OF THE INVENTION

This patent specification relates to systems and methods for enabling zero knowledge crypto-asset exchange

### BACKGROUND

The proliferation of mobile devices with Internet capabilities (e.g., mobile phones, wearable devices) has made it increasingly easy for users to conduct electronic commerce and online purchases using merchant websites and mobile applications. This has also led to an increased shift away from paper-based monetary schemes (e.g., the exchange of physical or paper currency) to instead rely upon electronic systems for monetary exchange. Many electronic payment systems have been developed for exchanging money, including the use of electronic wallets and electronic funds transfer (EFT). EFT includes a direct debiting/crediting of a user's bank account at the instance of the user from a remote location.

Another type of electronic system for monetary exchange is commonly referred to as an electronic peer-to-peer payment system or digital currency system. Bitcoin is one example of a digital currency system that utilizes cryptographic techniques, and thus the digital currency is referred to as cryptocurrency. Although there are many such cryptocurrencies, Bitcoin is one of the most well-known and thus will be discussed herein, as many other cryptocurrencies share similar features. Payments made using the Bitcoin system are recorded in a ledger (the “Block Chain”, which is maintained in parallel by many different entities in the system) using its own unique monetary unit, which is also called a “bitcoin.” The Bitcoin system has no central repository and no single administrator, and thus is viewed as a decentralized virtual currency. This is contrast with a FIAT currency. FIAT currency is legal tender whose value is backed by the government that issued it and is not backed by a commodity such as gold. For example, the U.S. dollar is fiat currency.

New bitcoins are created as a reward for payment processing work performed by computing devices involved in the Bitcoin system. For example, users may use their personal computing systems to verify and record transactions that are to be entered into the ledger. Users may verify transactions by solving mathematical problems linked to the transaction. This process is referred to as “mining”, and both individuals and companies engage in this activity to seek (optional) transaction fees and/or newly created bitcoins. When the user solves the mathematical problem associated with the transaction, that transaction is then appended to the end of the Block Chain. Users typically send and receive bitcoins electronically using wallet software on a personal computer, mobile device, via a web application, or using any other appropriate user computing device.

In addition to mining, bitcoins can also be obtained in exchange for fiat currency (i.e., currency which derives its value from government regulation or law, such as the U.S. Dollar or British Pound), products, and/or services. However, bitcoins themselves are not linked to any fiat currency and derive their value based on a perceived value of the bitcoins.

In practice, each time a node or “miner” (e.g., a user computing device in communication with the network) in the system finds the solution to a mathematical problem, a quantity of “new” bitcoins may be issued to that miner as a reward. Specifically, nodes perform work by repeatedly trying to solve instances of the mathematical problem through trial and error, with each attempt having an equal but very low chance of being a correct solution. When a node successfully solves the mathematical problem (i.e., the network node processes a “block” of transactions), the network node may be rewarded by receiving a programmed amount of bitcoins to compensate the operators of these nodes for their computational work and resources used to secure the bitcoin transactions. In addition, when the mathematical problem is solved, the transaction(s) linked to the mathematical problem are appended to the end of the block chain and distributed to the other nodes in the system.

More specifically, mining is the calculation of a cryptographic hash of a block header, which includes among other things a reference to the previous block (e.g., a previous transaction in the block chain), the current transaction, and a nonce (i.e., a 32-bit field having a random or pseudo-random value). If the determined hash value is found to be less than a current target (which may be inversely proportional to the difficulty), the user has successfully “solved” the problem, a new block may be formed in the block chain with the current transaction, and the miner may be rewarded a quantity of newly generated bitcoins. If the determined hash value is not less than the current target, a new nonce is generated and tried, and a new hash may be calculated. This computation may be done millions of times per second by each miner until the problem is solved.

Once generated or mined, a bitcoin may be stored in a user's bitcoin “wallet” which may be either stored on the user's user computing device by the bitcoin software or hosted on a third-party website or server computer. The wallet may show users their available bitcoin balance, previous transaction history, and the collection of bitcoin addresses they may use to send and receive bitcoins with other users. If an owner of a bitcoin decides to: (i) exchange a quantity of bitcoins for another form of currency, such as for U.S. dollars, and/or (ii) use a quantity of bitcoins as a form of payment for goods or services, the owner of the bitcoin transfers the bitcoin to a payee by digitally signing a hash of the previous transaction (involving the bitcoin) and a public key (also referred to as an “address”) of the payee and then adding these to the end of the bitcoin address. With such information viewable in the bitcoin address, the payee (and other nodes) can verify the chain of ownership. For example, when a bitcoin belonging to user A is transferred to user B, user A's ownership over that bitcoin is relinquished by adding user B's public key address to the bitcoin coin and signing the result with the private key that is associated with user A's address. User B now owns the bitcoin and can transfer it further. In this example, user A is prevented from transferring the already spent bitcoin to other users because a ledger of all previous transactions may be collectively maintained by the nodes of the network.

When one party wishes to transfer a bitcoin to another party, both parties have traditionally been required to download a “wallet” and exchange an address to commence with the transaction. For parties who have not yet downloaded the “wallet,” this presents an obstacle in commencing a cryptocurrency transaction. Moreover, assuming both parties have “wallets,” the requirement to share the address is yet another hurdle to conducting the transaction.

Thus, there is a need for new and enhanced methods conducting cryptocurrency transactions without requiring both parties to the transaction to have knowledge of the underlying mechanisms for enabling the transaction.

### BRIEF SUMMARY

Systems and methods for using a shared platform to transmit cryptocurrency to a zero knowledge recipient are described herein. A transferor can transmit crypto-assets to a transferee via a zero knowledge blockchain platform without having without requiring both the transferor and the transferee to have knowledge of the underlying mechanisms for enabling the transaction.

In one embodiment, a method is provided that includes receiving, by a first user interacting with a user interface of a zero knowledge blockchain platform (ZKBP), selection of one of a send transaction and a request transaction for transferring a crypto-asset, selection of one of a plurality of messaging platforms through which the crypto-asset is to be transferred, entry of contact information pertaining to a second user required by the selected platform, selection of a crypto-asset currency selected from a list comprising at least one crypto-asset currency supported by the ZKBP, and entry of a quantity in the selected crypto-asset currency for the crypto-asset. The method can include generating a zero knowledge link (ZKL) that is associated with the crypto-asset, transmitting the ZKL via the selected messaging platform to the second user, receiving confirmation of acceptance of the ZKL by the second user, and transferring the quantity in the selected currency of the crypto-asset between the first and second users in response to the received confirmation of acceptance.

In one embodiment, generating the ZKL can include modifying a transaction on a blockchain of the crypto-asset being transferred between the first and second users.

In one embodiment, modifying the transaction on the blockchain can include incorporating the quantity, a sending blockchain address, a receiving blockchain address, and a transaction identification.

In one embodiment, modifying the transaction on the blockchain can include incorporating the selected currency, the entered quantity, the first user, the second user, and a time stamp.

In one embodiment, receiving confirmation can include verifying that the second user has accessed the ZKBP using the ZKL and has accepted transfer of the crypto-asset using the ZKBP.

In one embodiment, the plurality of messaging platforms can include email, short message service (SMS), and at least one social media platform.

In one embodiment, the plurality of messaging platforms can include native messaging within the ZKBP.

In one embodiment, the at least one crypto-asset currency supported by the ZKBP can include a blockchain that is managed by the ZKBP, wherein the ZKBP handles transferor to transferee blockchain transactions without requiring the transferor and the transferee to possess transferor and transferee addresses of the blockchain transaction.

In one embodiment, the list can include a plurality of crypto-asset currencies supported by the ZKBP.

In one embodiment, the method can include receiving a deposit corresponding to the at least one crypto-asset currency supported by the ZKBP.

In one embodiment, the method can include managing the deposit in a user wallet on behalf of the first user.

In one embodiment, the method can specify that the receiving by the first user interacting with the user interface of the ZKBP further comprises entering a note associated with the crypto-asset.

In another embodiment, a method is provided that can include transmitting a zero knowledge link (ZKL) to a first user via a sharing platform, wherein the ZKL is associated with transfer of a crypto-asset and is generated by a zero knowledge blockchain platform (ZKBP), wherein the ZKL comprises a crypto-asset currency, a value, the first user, a second user, and a time stamp; in response to receiving an indication that the first user has acknowledged receipt of the ZKL, presenting the first user with an option to accept or deny transfer of the crypto-asset in a user interface of the ZKBP; and automatically populating a first user wallet corresponding to the first user with the crypto-asset in response to user acceptance of the transfer of the crypto-asset by crediting the first user wallet with the value in the currency of the crypto-asset and by debiting a second user wallet corresponding to the second user by the value in the currency, wherein the ZKBP performs the crediting and the debiting.

In one embodiment, the ZKBP performs the crediting and debiting by processing blockchain alphanumeric sequences corresponding to the crypto-asset.

In one embodiment, the ZKL is generated in response to interaction with the ZKBP by the second user.

In one embodiment, the interaction with the ZKBP by the second user can include selection of one of a send transaction and a request transaction for transferring the crypto-asset, selection of the messaging platform from one of a plurality of sharing platforms through which the crypto-asset is to be transferred, entry of contact information pertaining to the first user required by the selected sharing platform, selection of the crypto-asset currency selected from a list comprising at least one crypto-asset currency supported by the ZKBP, and entry of the value in the selected crypto-asset currency for the crypto-asset.

In one embodiment, the sharing platform is selected from the group of email, short message service (SMS), and a social media platform.

In one embodiment, the sharing platform is a native message within the blockchain management platform.

In one embodiment, the ZKBP handles transferor to transferee blockchain transactions without requiring the transferor and the transferee to possess a transferor address and a transferee address of the blockchain transaction.

In one embodiment, the method can specify that in response to receiving an indication that the first user has acknowledged receipt of the ZKL: generating the first user wallet if the first user wallet has not been previously generated for the first user; associating the crypto-asset with the first user wallet; and displaying an accept transfer button and a reject transfer button in the first user wallet.

In one embodiment, the method can specify cancelling the ZKL in response to determining that the first user has not acknowledged receipt of the ZKL within a fixed period of time with respect to the time stamp.

In one embodiment, the method can specify returning the value of the cyptro-asset to the second user in response to user rejection of the transfer of the crypto-asset.

In yet another embodiment, a method can include receiving a crypto-asset transfer request from a first user, the crypto-asset transfer request comprising a social media platform, a recipient, and a value amount; generating a zero knowledge link (ZKL) associated with the crypto-asset transfer request; transmitting the ZKL to the recipient via the social media platform; receiving recipient acceptance of the ZKL; and in response to the received recipient acceptance, crediting the recipient with the value amount and debiting the value amount from the first user without requiring the first user or the recipient to have knowledge of a blockchain address underlying the crypto-asset transfer request.

In yet another embodiment, a system for executing any one of the aforementioned method embodiments is provided.

In yet another embodiment, a program for causing a computer or server system to execute any one of the aforementioned method embodiments is provided.

A further understanding of the nature and advantages of the embodiments discussed herein may be realized by reference to the remaining portions of the specification and the drawings.

### BRIEF DESCRIPTION OF THE DRAWINGS

FIGS. 1A-1D show example screen shots of a conventional wallet that may be used to transfer crypto-assets from one user to another;

FIG. 2 shows an illustrative system according to an embodiment;

FIG. 3 shows illustrative user interface according to an embodiment;

FIGS. 4-6 show illustrative user interface screens according to various embodiments;

FIGS. 7A and 7B show illustrative user interface screens according to various embodiments;

FIGS. 8 and 9 show illustrative user interface screens according to various embodiments;

FIG. 10 shows illustrative specification of a crypto-asset according to an embodiment;

FIG. 11 shows illustrative block rewards according to an embodiment;

FIG. 12 shows illustrative rewards per block according to an embodiment;

FIG. 13 shows illustrative process of first and second users interfacing with the ZKBP according to an embodiment;

FIG. 14 shows an illustrative process for enabling a user send a crypto-asset to a user who has no knowledge the underlying crypto-asset being transmitted according to an embodiment;

FIG. 15 shows an illustrative process for enabling a zero knowledge recipient of a crypto-asset to accept the crypto-asset being transmitted according to an embodiment; and

FIG. 16 shows illustrative process according to an embodiment;

### DETAILED DESCRIPTION

Illustrative embodiments are now described more fully hereinafter with reference to the accompanying drawings, in which representative examples are shown. Indeed, the disclosed systems and methods may be embodied in many different forms and should not be construed as limited to the embodiments set forth herein. Like numbers refer to like elements throughout.

In the following detailed description, for purposes of explanation, numerous specific details are set forth to provide a thorough understanding of the various embodiments. Those of ordinary skill in the art will realize that these various embodiments are illustrative only and are not intended to be limiting in any way. Other embodiments will readily suggest themselves to such skilled persons having the benefit of this disclosure.

In addition, for clarity purposes, not all of the routine features of the embodiments described herein are shown or described. One of ordinary skill in the art would readily appreciate that in the development of any such actual embodiment, numerous embodiment-specific decisions may be required to achieve specific design objectives. These design objectives will vary from one embodiment to another and from one developer to another. Moreover, it will be appreciated that such a development effort might be complex and time-consuming but would nevertheless be a routine engineering undertaking for those of ordinary skill in the art having the benefit of this disclosure.

Creating and innovating are innate to humanity. These tenets, coupled with the explosion of technology and Moore's Law, have increased the efficiency of that process a hundredfold. For example, the original Ford Model T was developed over a hundred years ago, and within a century, the Model T has been distilled and refined into the automobiles of today. Social media has done the same exact thing with traditional communication methods, which have been distilled and refined to the social media platforms that are commonly used today. In ways similar to what social media has done for communication, the blockchain and more specifically cryptocurrency, has transformed the financial technology sector. Cryptocurrency has provided new ways of handling financial transaction, and has made financial transactions faster, more secure, and accessible to everyone. The applications of the blockchain have near limitless potential because of its adaptability to any situation. Embodiments discussed herein merge use of social media platforms and cryptocurrency to provide a platform that enables its users to send and receive cryptocurrency over existing social media networks.

The blockchain is an encrypted public ledger designed to keep track of cryptocurrency transactions. In an exemplary case use, the blockchain was developed for Bitcoin. In most circumstances, it works as a secure, electronic transaction processing and record-keeping system, but it has numerous applications. This allows various connected participants within a public or private network, to track the information, thereby eliminating the need for any kind of antiquated third-party verification, as is the case with the traditional banking model. The increasing adoption of this secure technology in the financial services sector and anticipated adoption across the public sector, including healthcare segments, fuels the need for a cryptocurrency platform that easily allows parties to instantaneously exchange funds.

In conventional cryptocurrency transactions, users are forced to engage in a relatively laborious process before they are actually able to conduct cryptocurrency transactions. For example, a user is first required to log in to a website associated with a particular cryptocurrency provider (e.g., Bitcoin or Ethereum) and download a “wallet” from that particular cryptocurrency provider. Thus, in order to send or receive cryptocurrency, the user must have a wallet pertaining to every cryptocurrency provider the user desires to trade. For example, if the user wishes to trade in Bitcoin and Ethereum, the user must download a Bitcoin wallet and an Ethereum wallet. As result, the mere process of procuring a “wallet” is a hurdle in conducting cryptocurrency. In addition, there is no “app” store in which user can download a cryptocurrency specific app from a centralized location. Moreover, a wallet must be downloaded to each device being used by the user. If the user has a first device (e.g., MacBook or PC), the user has to download a wallet on to the first device. If the user has a second device (e.g., a smartphone), the user has to download wallet onto the second device. Downloading a wallet to each device is onerous and time consuming.

Once the user obtains the wallet, the user is then faced with the hurdle of navigating the wallet. In particular, in order for a sender to send cryptocurrency to a recipient, the recipient has to locate his address and provide that address to the sender. The address is difficult to find within the wallet and once the user locates the address, the user has to figure out a way provide that address to the sender. An issue here is that the address is large alphanumeric sequence that is practically impossible to memorize. As a result, the user has to copy and paste the address. If the user does not correctly copy the entire address, then the transaction cannot take place. In one approach, the address can be printed onto a piece of paper, which is then provided to the sender, who then has to type in the large alphanumeric sequence into his wallet. In another approach, the address can be included in an email that is sent to the sender. The process of finding the address, copying the address, providing the copied address to the sender, and then having the sender incorporate the address into his wallet is cumbersome, time consuming, and error prone.

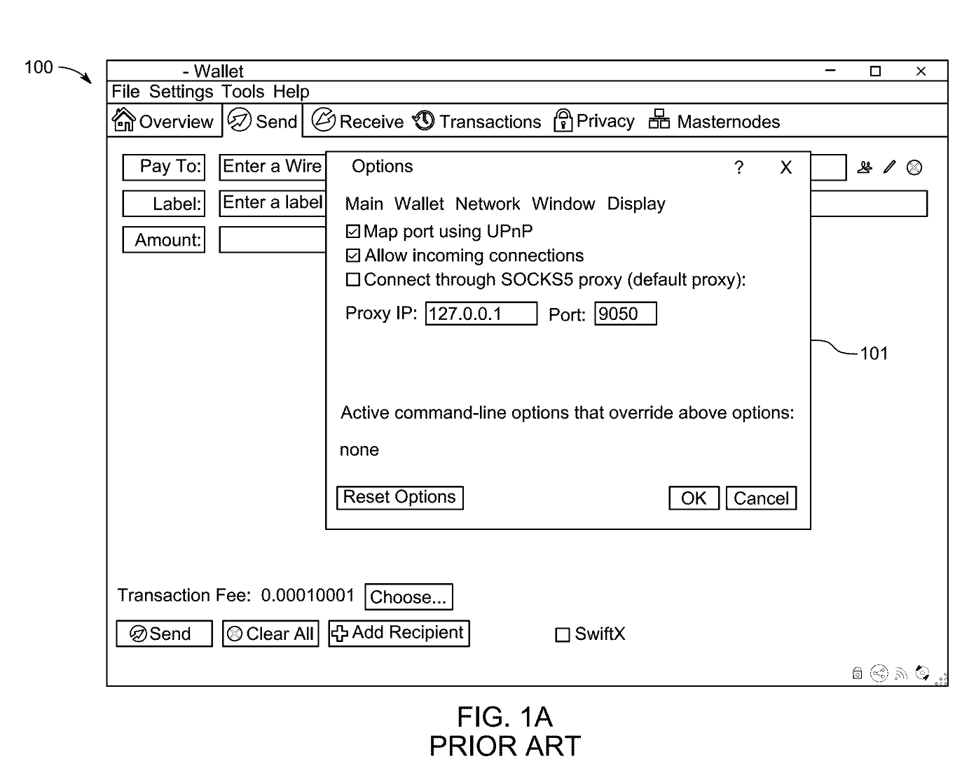

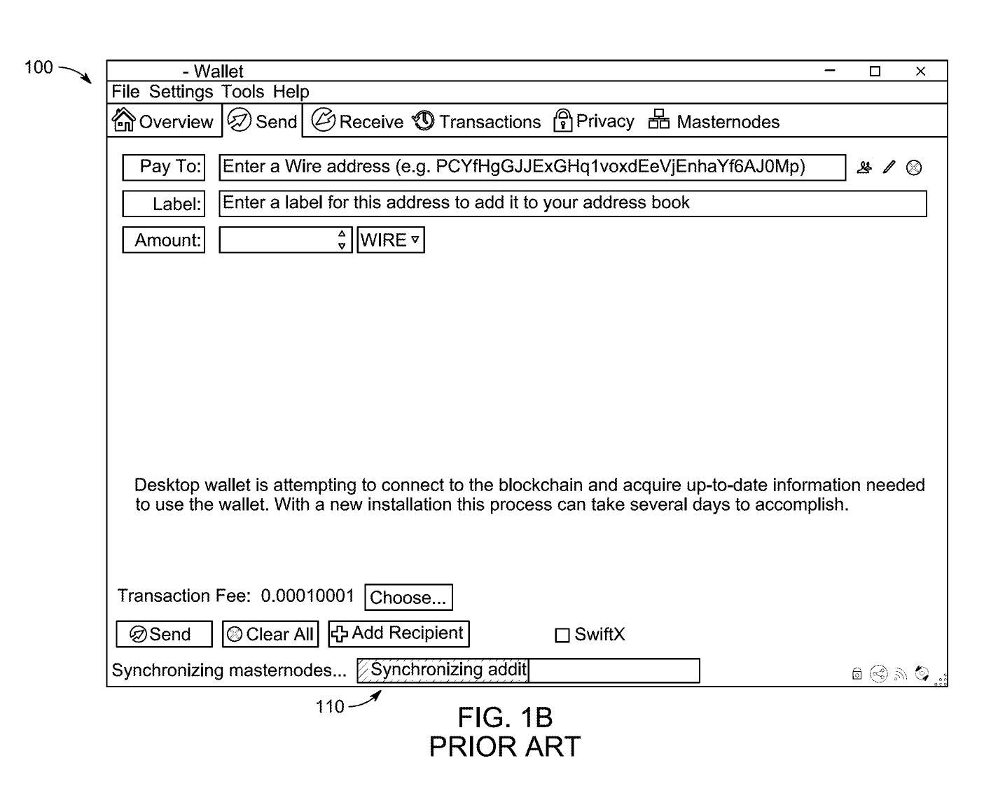

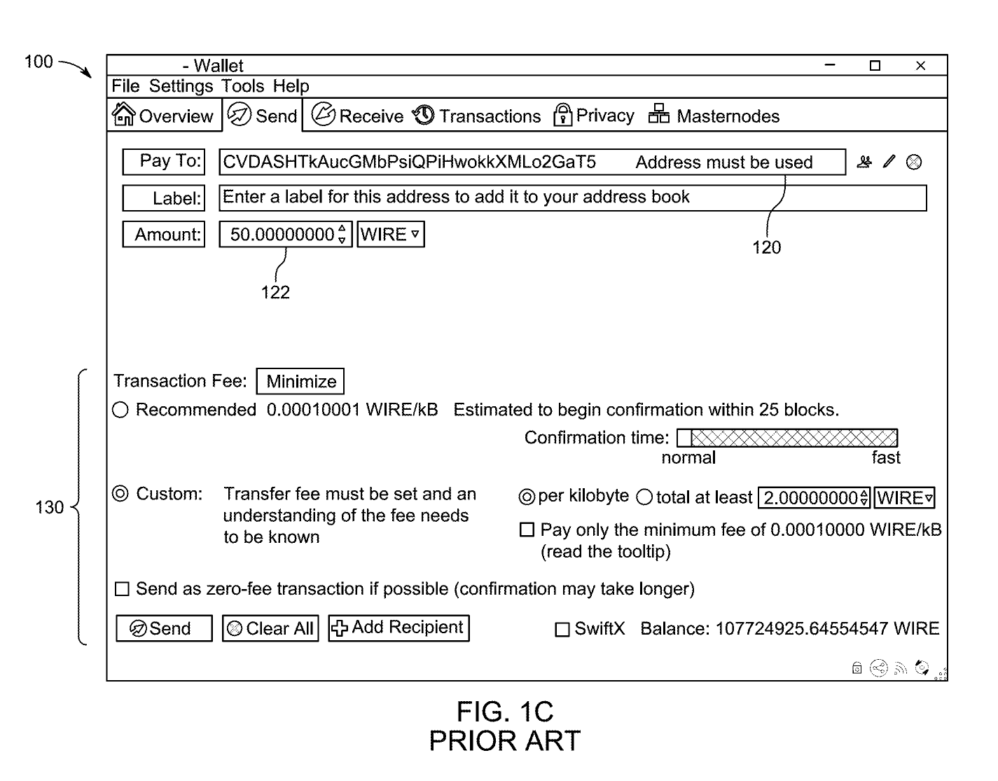

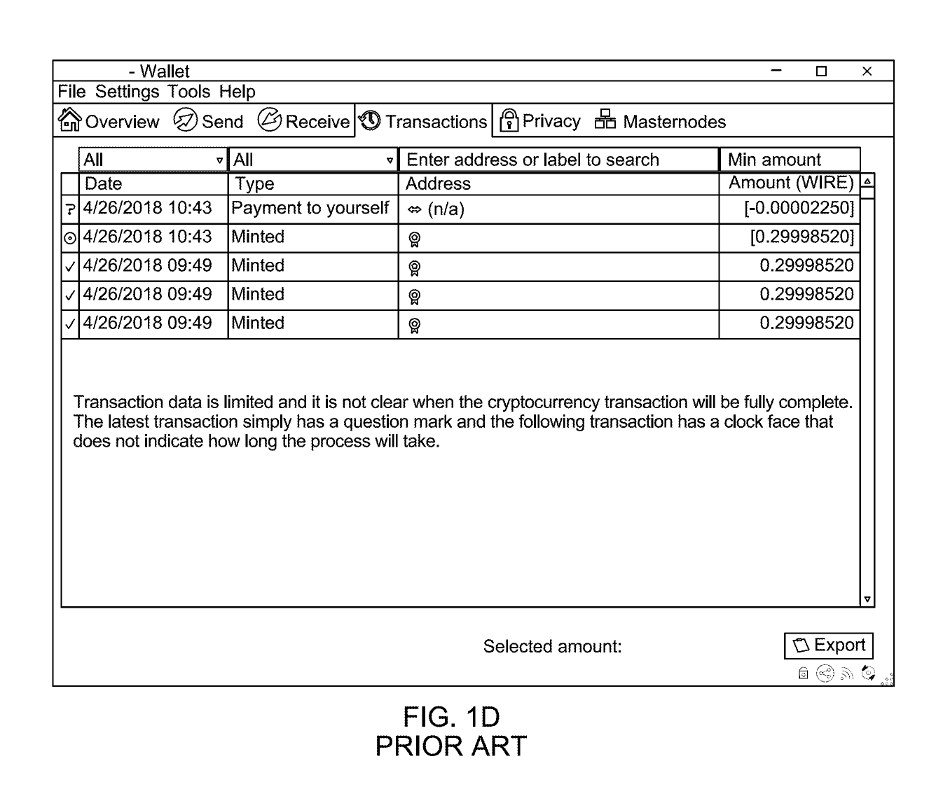

FIGS. 1A-1D show example screen shots of a conventional wallet that may be used to transfer crypto-assets from one user to another. FIG. 1A shows setup screen 101 in which a user is required to define network settings for enabling wallet 100 to access a blockchain. The network settings can include port opening or forwarding router settings such as UPnP, proxy, firewall, and anti-virus notifications. Selecting the correct network settings in order to access the blockchain is onerous and requires substantial technical understanding. When the network setting are selected, wallet 100 is then required to connect the blockchain and acquire information required to use wallet 100. Synchronization status indicator 110 (of FIG. 1B) shows the progress of blockchain synchronization. Initial installation setup processes such as this can take hour if not days to complete.

When a user wishes to send cryptocurrency to another person or business, and address for the recipient must be known. In addition, the recipient must be prepared to receive the cryptocurrency being sent. The steps for using a legacy wallet to send cryptocurrency can be performed as follows. First, the sender must have a wallet that is functioning and that hold cryptocurrency. Second, the recipient must have a wallet that is functioning and the recipient must know how to generate an address for the sender's funds to be sent. The recipient must provide the sender with the address. The address is typically a long string of characters that is very difficult to remember. An exemplary address may resemble something like CeYvUrfVjXjscGefTleEfjEjkbVijEdrFM. The sender must then enter this address in pay to field 120, enter an amount in the amount field 122, as shown in FIG. 1C. The sender is required to adjust the network fee based on network congestion. For example, the sender can select fees in fee section 130 of wallet 100. A fee that is too low can cause the transaction to stay in a process state for several days. A fee set too high will cost the sender unnecessary fees and the transaction can still take several minutes or hours based on congestion. Neither the recipient nor the sender has how long the transaction will take. Examples of unknown transactions are shown in FIG. 1D, where one transaction is marked with a question mark and another transaction is marked with a clock.

Embodiments discussed herein eliminate the wallet-to-wallet transaction issues that plague conventional cryptocurrency transactions, such as those described above, by providing a zero knowledge blockchain platform that seamlessly leverages existing shared platforms to conduct cryptocurrency transactions. The existing shared platforms can include short message service (SMS) (e.g., text), email, social media via API access (e.g., Twitter, Instagram, Facebook), or a native application. The platform according to embodiments discussed herein enable users of the platform to operate according to a zero knowledge paradigm in which the transferor and transferee in a cryptocurrency transaction do not need to have prior knowledge of a blockchain address in order to execute the cryptocurrency transaction. The zero knowledge platform enables users to send and receive cryptocurrency through any one of multiple shared platforms in which the sender only needs to know receiver's social media contact (e.g., email address, phone number, social media account name, etc.). The platform leverages blockchain technology to enable cryptocurrency to be sent easily, quickly, and securely over existing networking infrastructure where no prior setup is needed by the recipient, nor any advanced knowledge of the transaction itself.

The zero knowledge blockchain platform can operate generally and improves on conventional crypto-asset transactions as follows. The zero knowledge platform does not require a wallet to be downloaded and configured. The zero knowledge platform functions as a web interface and it does not need to be configured either. As soon as a user logs into the zero knowledge platform, the platform automatically configures the user a new wallet (if such a wallet does not already exit) and populates the user's wallet with the appropriate crypto-asset credits or debits.

The platform automatically connects to the blockchains of the coins and tokens that are on the platform. The connection stays synchronized at all times and does not need to be maintained by the user. The connection is ready anytime the user wishes to utilize the platform.

The user does not use blockchain addresses to send or receive cryptocurrency. Blockchain addresses are replaced with a ZKBP username, social media username, email address or phone number. A sender can send crypto-assets to anyone if the sender has the recipient's ZKBP username, social media username, email address, or phone number. A zero knowledge link is generated as part of the crypto-asset transaction. The zero knowledge link is unique for each transaction, and is transmitted via the shared platform to a recipient. Alternatively, a user copy of the zero knowledge link (e.g., a URL link) can be generated so that users can send the like using any desired medium. The zero knowledge link enables the transferor and the transferee to not have knowledge of the incoming transaction nor prepare in any manner for the transaction.

The crypto-asset transaction is instant and does not rely on existing blockchains to process. A benefit of operating independently of existing blockchain is that blockchain fees are not applicable. This allows for instant and economical transfers.

The recipient can be notified of zero knowledge link via the zero knowledge platform, social media notifications, email or SMS text message that cryptocurrency has been sent to them. In addition, due to the URL (link) option, the recipient can be notified of the transaction using any medium (e.g., photograph, message board, gif, postal mail, courier service, telegram, fax, encrypted message/file, video or audio) to transfer information.

The recipient, in response to receiving the zero knowledge like, and interacting with it (e.g., by clocking on the link or typing it into a web browser), can be directed a user interface of the zero knowledge platform. Upon arriving at the platform the user can login to an existing account or create an account and login. When the user is logged into the platfoiui, the platform can prompt the user to accept or deny the transfer, and the selection option can be processed immediately. If the user accepts, and wallet does not already exist for that user, a wallet is instantly created and configured for that user without requiring any further input from the user. If the user already has a wallet on the platform, then that wallet is credited or debited accordingly.

The recipient can view the crypto-assets that exist in his wallet and view status of pending and past transactions. If the recipient chooses to do so, the recipient can send the funds in the same manner listed above instantly, without having to wait for confirmations or blockchain processing.

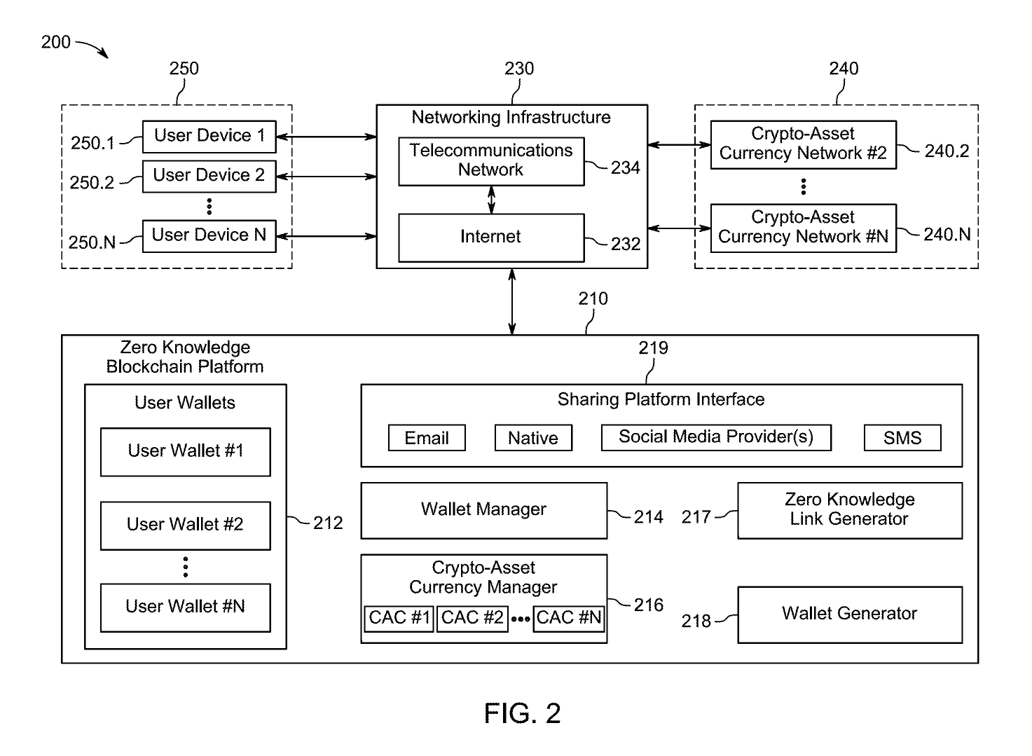

FIG. 2 shows an illustrative system 200 according to an embodiment. System 200 can include zero knowledge blockchain platform (ZKBP) 210, networking infrastructure 230, crypto-asset currency networks 240, and user devices 250. Networking infrastructure 230 can serve as a nexus for enabling user devices 250 to interact with ZKBP 210 and vice versa, and for enabling crypto-asset currency networks 240 to interact with ZKBP 210 and vice versa. Networking infrastructure 230 can include Internet 232 and telecommunications network 234. User devices 250 can include user devices 250.1, 205.2, through 250.n. User devices 250 can include any suitable device for interfacing with ZKBP 210. Such devices can include mobile devices, desktop computers, laptop computers, tablet devices, and the like. Crypto-asset currency networks 240 can include any number of networks specifically dedicated to a particular crypto-asset currency. Each crypto-asset currency networks is labeled as network 240.2 through 240.n. An example of a specific crypto-asset currency network can include Bitcoin or Ethereum.

ZKBP 210 can include user wallets 212, wallet manager 214, crypto-asset manager 216, zero knowledge link generator 217, wallet generator 218, and sharing platform interface 219. User wallets 212 can represent the accounts of each user of BKBP 210. Each of user wallets 212 can include information pertaining to each crypto-asset currency that the user has in his or her possession, transaction information (e.g., pending transactions, past transactions, scheduled transactions, etc.), contact information, a sharing platform interface log-in credentials. Wallet manager 214 can manage each of user wallets 212. For example, when a user interfaces with ZKBP 210 (e.g., via a user interface supported by ZKBP 210) to perform an action, wallet manager 214 can account for the action in that particular user wallet. Crypto-asset currency manager 216 may manage data related to one or more crypto-asset currencies. The crypto-asset currencies (CAC) are illustrated at CAC#1, CAC#2, and CAC#N, and represent the different crypto-asset currencies that may be accessed via ZKBP 212. Manager 216 can manage blockchain transaction with respect to each CAC. In some embodiments, CAC#1 may be a native crypto-asset currency handled exclusively by ZKBP 210 in which case manager 216 may not need to access currency networks 240. The other CACs, such as CAC#2 and CAC#N may be non-native crypto-asset currencies and correspond to specific currency networks (e.g., Network 240.2 and Network 240.N). For the non-native crypto-asset currencies, manager 216 can manage the blockchain of these crypto-currencies in conjunction with currency networks 240.

Zero knowledge link generator 217 can generate a zero knowledge link (ZKT) that can be transmitted to a user via sharing platform interface 219. The ZKL may be created by ZKL generator 217 when a first user of ZKBP 210 desires to transfer crypto-assets in one of CACs to a second user. The second user does not need to provide any information (e.g., blockchain address information) to the first user in order for the first user to transfer a specified amount of crypto-assets to the second user. ZKL generator 217 may operate in conjunction with wallet manager 214, crypto-asset manager 216, and sharing platform interface 219 to produce the ZKL. For example, the ZKL can include a crypto-asset currency, a value, the first user, the second user, and a time stamp. When the ZKL is generated, it may be transmitted to the second user via a selected platform within sharing platform interface 219.

Sharing platform interface 219 can provide access to different platforms that can be used to deliver the ZKL to another person. The different platforms can include email 219.1, native communication 219.2, social media providers 219.3, short message service (SMS) 219.4, and other suitable platform. Email 219.1 may be used to send an email containing the ZKL to another user. Native communication 219.2 can refer to messages sent within ZKBL 210. That is, native communication 219.2 is hosted by ZKBL 210 and therefore does not need to access a third party service or host to transmit the ZKL. Social media providers 219.3 can refer to third party platforms that facilitate communications among their users. Examples of social media providers can include Facebook™, Twitter™, Instagram™, Pinterest™, Snapchat™, LinkedN™, YouTube™, Tumblr™, Reddit™, Baidu™, WeChat™, Viber™, etc. SMS 219.4 can refer to, for example, text message services that can send the ZKL via telecommunications network 234. Custom platforms can also be used to communicate the ZKL in which the user is provided with a copy of the ZKL and the user can transmit the ZKL using any means he or she desires.

Wallet generator 218 can generate a user wallet. The generated user wallet can be associated with a ZKL and can be included as part of user wallets 212. For example, if the ZKL is being sent to a user who does not have an account with ZKBP 210, wallet generator 218 may create a wallet for that user. This way, when that user accesses the ZKL, the user can be presented with his or her wallet when the user logs into the ZKBP 210. The wallet can show the crypto-asset being transferred and the user can be presented with several options in handling the transfer. In another embodiment, if a user logs into ZKBP 210 for the first time (irrespective of having received ZKL), wallet generator 218 may be accessed to generate a wallet for that user.

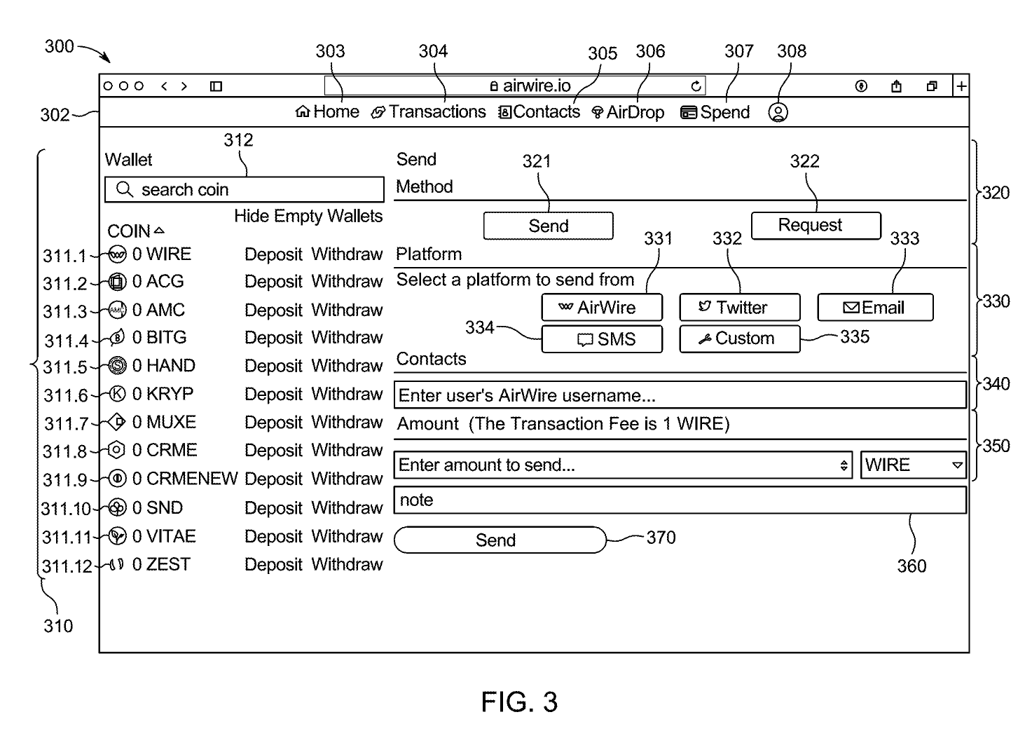

FIG. 3 shows illustrative user interface 300 according to an embodiment. User interface 300 may be representative of home web page supported by ZKBP 200. User interface 300 can include menu bar 302 with selectable items, including home 303, transactions 304, contacts 305, AirDrop 306, Spend 307, and Account 308. Selection of any one of items 303-308 can allow the user navigate to a top menu corresponding to the selected item. User interface 300 can also include wallet 310, transfer options 320, share platforms 330, contacts 340, crypto-asset details 350, notes field 360, and transfer confirmation button 370. Wallet 310 can include a searchable list of crypto-asset currencies 311.1-311.12 available for transfer. Each crypto-asset currency 311.1-311.12 can include the name of currency, the number or balance of crypto-assets in that currency available to the user, an option to deposit additional crypto-assets in that particular currency, and an option to withdraw crypto-assets in that particular currency. Wallet 310 can include search box 312 for searching for a particular crypto-asset currency. Crypto-asset currency 311.1 may be a native currency to ZKBP 200, whereas crypto-asset currencies 311.2-311.12 are non-native currencies that can be accessed via user interface 300. Crypto-asset currencies 311.1-311.12 may be managed, at least in part, by wallet manager 214. In addition, the non-native currencies may be associated with one of the crypto-asset currency networks 240.

Transfer options 320 can include, for example, send option 321 and request option 322. Send option 321 is selected to transfer crypto-assets to another. When send option 321 is selected, the user will be the transferor and the other person will be the transferee. Request option 322 is selected to request crypto-assets from another. When request option 322 is selected, the user will be the transferee and the other person will be the transferor.

Share platforms 330 can include several different platforms that can be selected for transmitting a ZKL. Example share platforms can include a native platform 331, social media specific platform 332, email platform 333, SMS platform 334, and custom platform 335. If desired, other social media specific platforms can be included.

Contacts 340 enables a user to enter the name associated with a crypto-asset transfer. The actual contact information entered in contacts 340 may be share platform specific. For example, native share platform 331 is selected, and thus the contact information should match user name criteria of that platform. For example, if email platform 333 is used, an email address can be entered. If SMS platform 334 is used, a phone number can be entered.

Crypto-asset details 350 can allow the user select a crypto-asset currency from a drop down list of available crypto-asset currencies (e.g., the same currencies shown in wallet 310) and enter an amount of the selected crypto-asset currency to transfer. If desired, the user can enter a note in notes field 360.

Transfer confirmation button 370 may be selected after the user has selected one of options 321 and 322, selected a platform, entered the contact information, selected a crypto-asset currency and entered value. The ZKL may be generated by ZKL generator 217 in response to selection of button 370 and transmitted via the selected share platform.

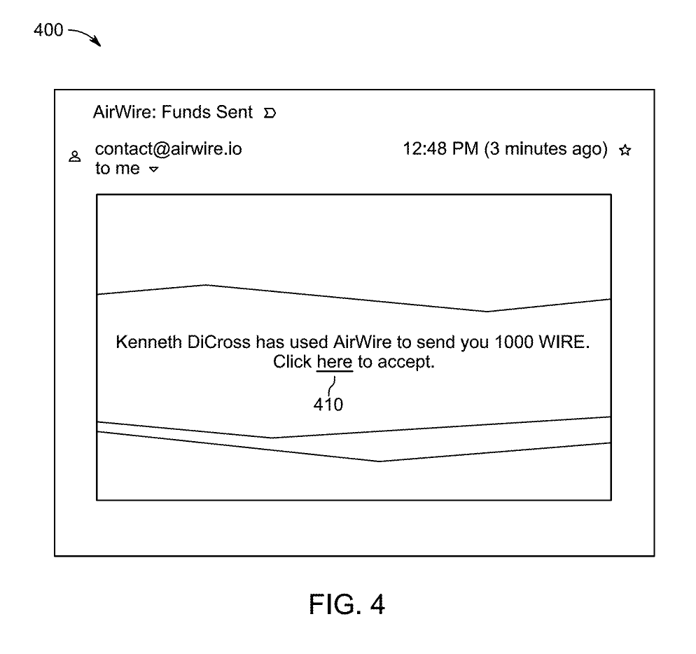

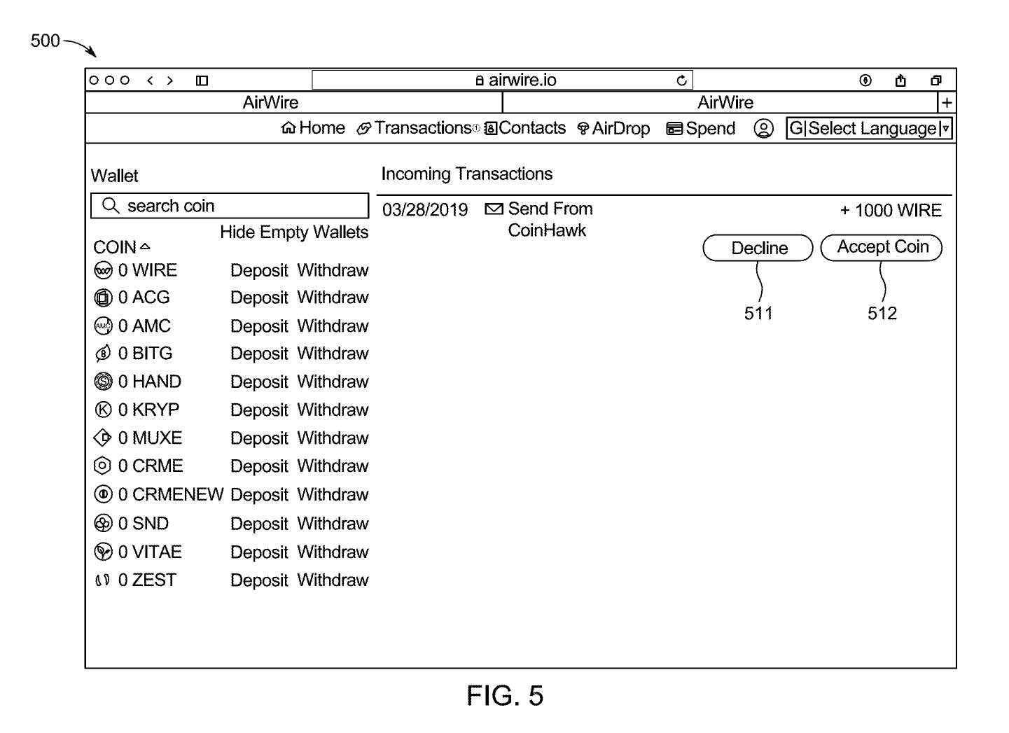

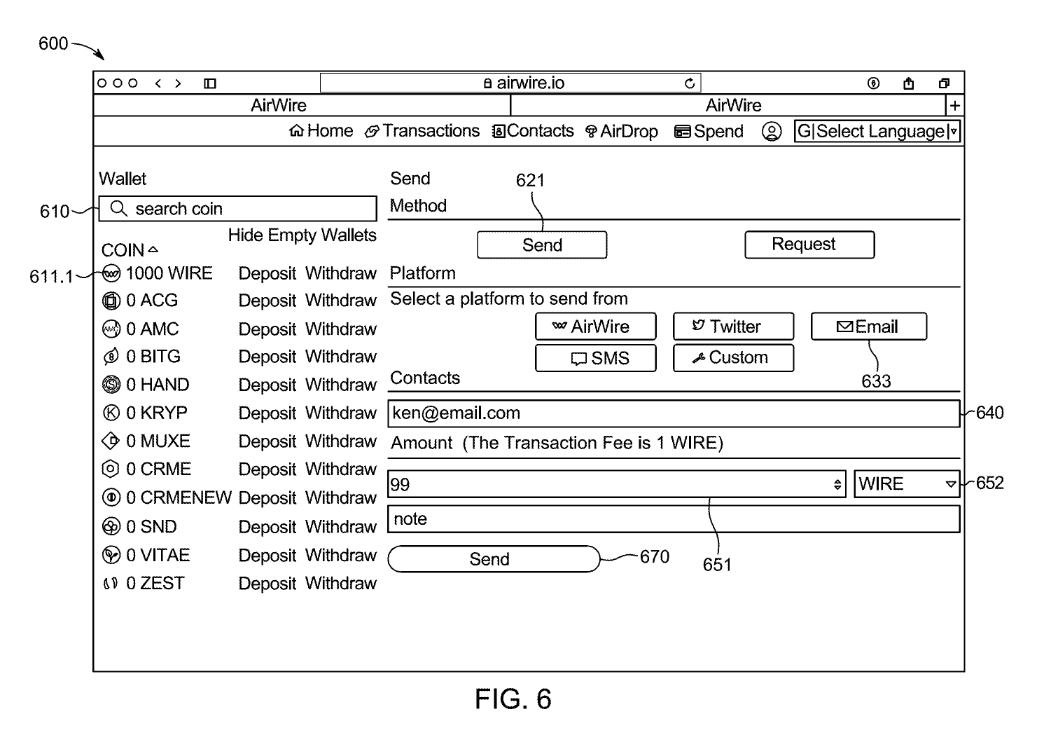

FIGS. 4-6 show an illustrative sequence in which a ZKL is received by a user and the user accepts a crypto-asset via the ZKL. FIG. 4 shows illustrative ZKL 400 that was transmitted by ZKBP 200 via a native platform to a recipient. ZKL 400 indicates that 1000 Wire (e.g., a native crypto-asset currency) has been sent to the recipient. ZKL 400 may be presented within the user interface supported by ZKBP 200, though it should be understood that the ZKL 400 can be received by any suitable platform. If the user wishes to accept the transfer, he or she may select item 410. In response to selection of item 410, the user may be directed to user interface 500 of FIG. 5. FIG. 5 shows that an incoming transaction of 1000 Wire is available and that the user can select decline button 511 or accept button 512. If the user selects decline button 511, the crypto-currency transaction is cancelled and the 1000 Wire are returned to the sender. If the user selects accept button 512, the user may be presented with user interface 600 of FIG. 6. FIG. 6 shows that 1000 Wire is now available in wallet 610 as part of crypto-asset 611.1.

The illustrative sequence shown in FIGS. 4-6 shows how crypto-assets can be transmitted between two parties without either party having any knowledge of the underlying blockchain transaction. That is, neither party has to use a specific blockchain address or setup a wallet (or otherwise perform the complicated and error prone steps discussed above in connection with FIGS. 1A-1D) in order to transfer the crypto-asset. As shown in this illustrative sequence, the user received the ZKL, accepted it, and was provided with wallet that is automatically populated with the transferred crypto-assets. The transfer of the crypto-assets can be implemented immediately since there is no need to access a remote currency network. Moreover, the blockchain transaction corresponding to the transfer of crypto-assets are handled “behind-the-scenes” by ZKBP 200 (e.g., by wallet manager 214 and crypto-asset currency manager 216).

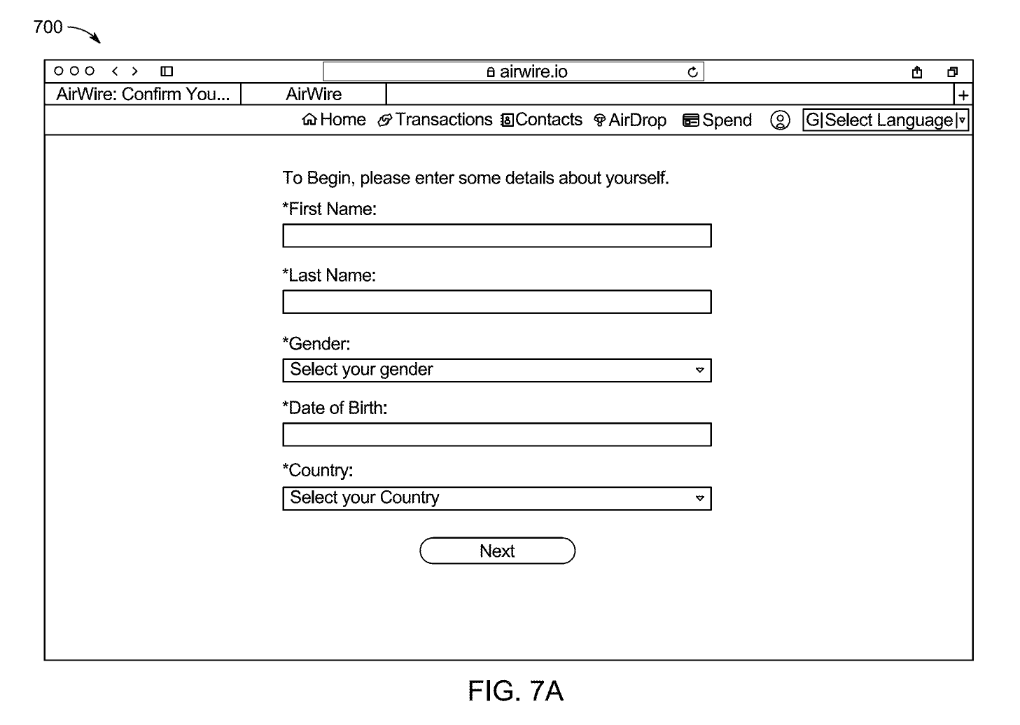

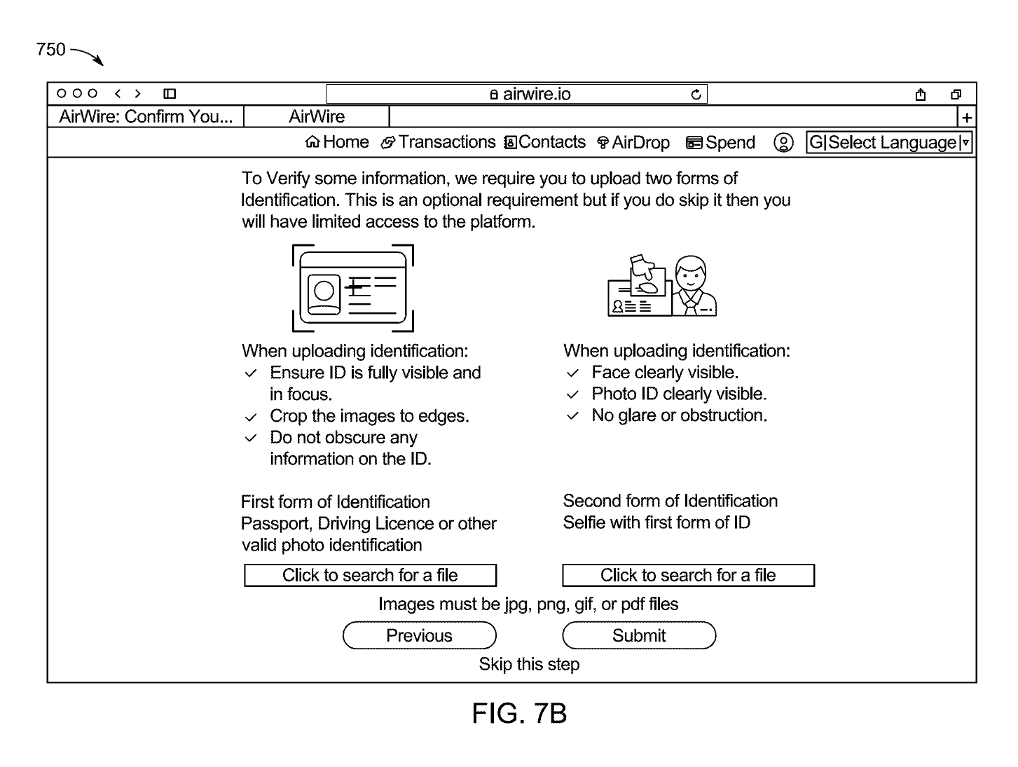

If the recipient of a ZKL has not set up an account with ZKBP 200, that user may be required to setup an account. For example, the user may be presented with user interface screens 700 and 750 of FIGS. 7A and 7B, respectively. User interface screen 700 ask the user to input basic information such as first and last name, gender, date of birth, and country. User interface screen 750 can be presented to satisfy “know your customer” laws by requiring the user to submit multiple forms of identification.

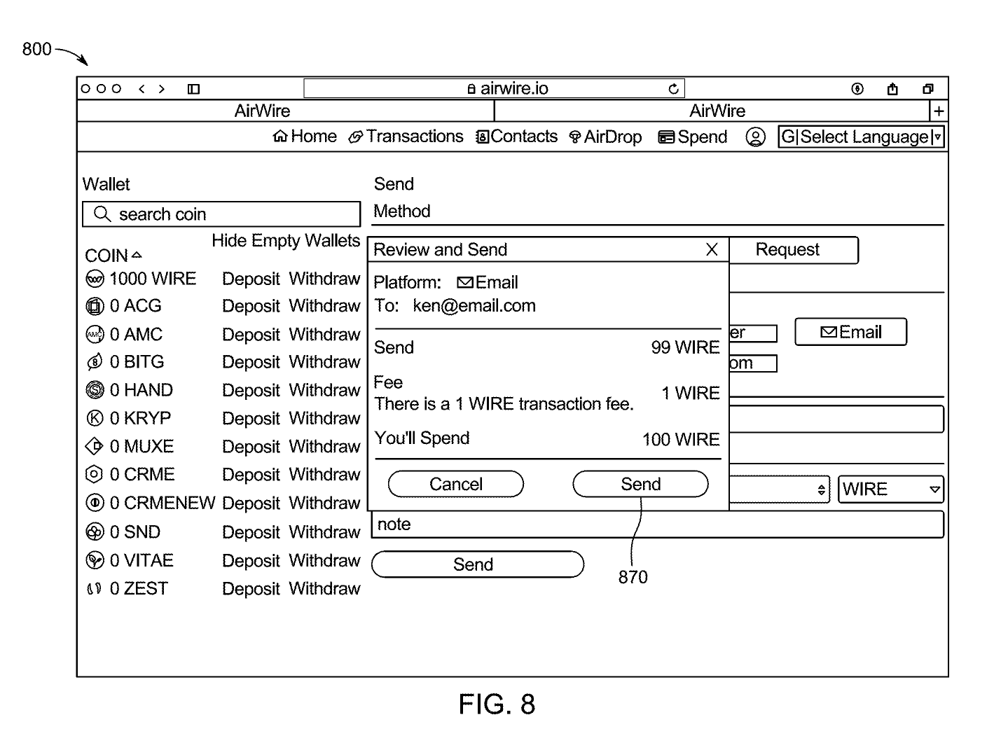

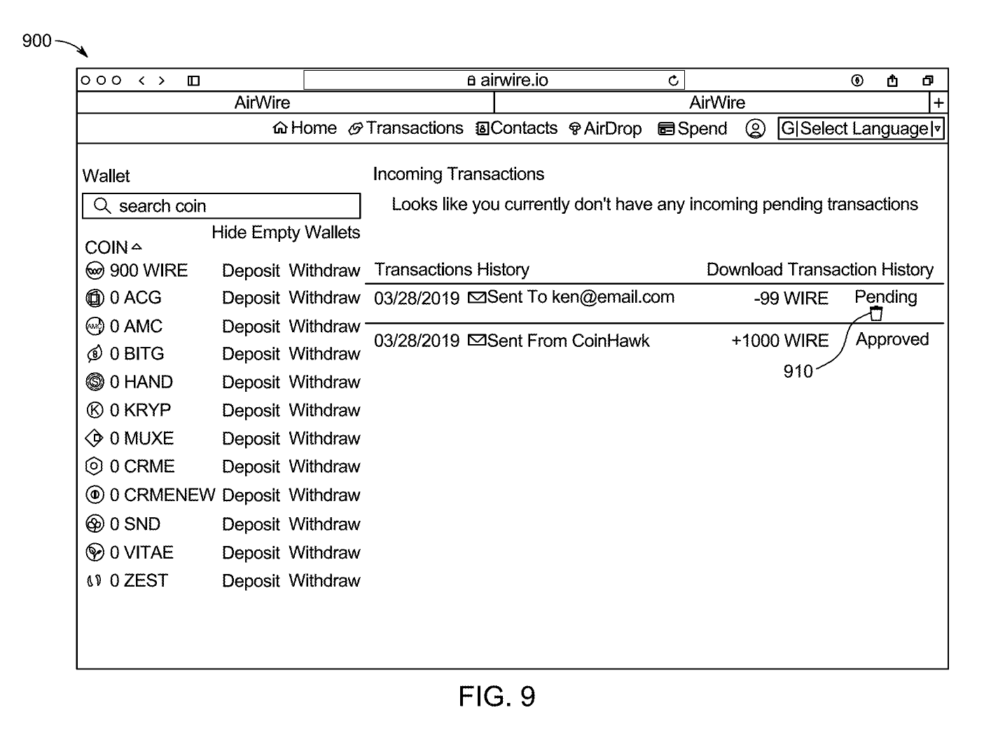

Referring now to FIGS. 6, 8, and 9, a sequence showing the user generation of a crypto-asset transfer is shown. As shown in FIG. 6, the user selected send option 621, email platform 633, entered contact information contact box 640, entered value of 99 in box 651, and selected native crypto-asset currency 652. When button 670 is pressed, confirmation user display 800 may be displayed as shown in FIG. 8. Confirmation user display 800 shows selected share platform, the recipient, the amount, the selected crypto-asset currency, and the fee. When the user selects send button 870, a ZKL is generated (e.g., by ZKL generator 217) and the recipient is sent the ZKL via the selected shared platform. After the ZKL is sent, and the user selects to view transactions user screen 900 of FIG. 9, the transaction history shows that 99 Wire transfer is pending. If desired, the user can cancel the transfer by selecting trash icon 910. When the recipient accepts the 99 Wire, the transaction history will change to approved, and ZKBP 200 can make the appropriate adjustments to the sender's wallet and the recipient's wallet.

Many different crypto-asset currencies may be supported by ZKBP 200. A native crypto-asset currency, referred to herein as Wire or a Wire token, uses the Xevan algorithm, founded by the Bitsend developers. The Xevan is a stable, ASIC resistant and efficient algorithm. The Xevan hash algorithm is a unique combination from the dual X17 difficulty algorithm with an extension to 128 bits. Security and privacy are top priority when it comes to the WIRE token and were one of the first things Social Wallet wanted to ensure in its creation. Coin mixing and ZeroCoin protocols are integrated into Wire. Both of these features allow for transaction mixing, anonymous sending, and freedom from prying eyes.

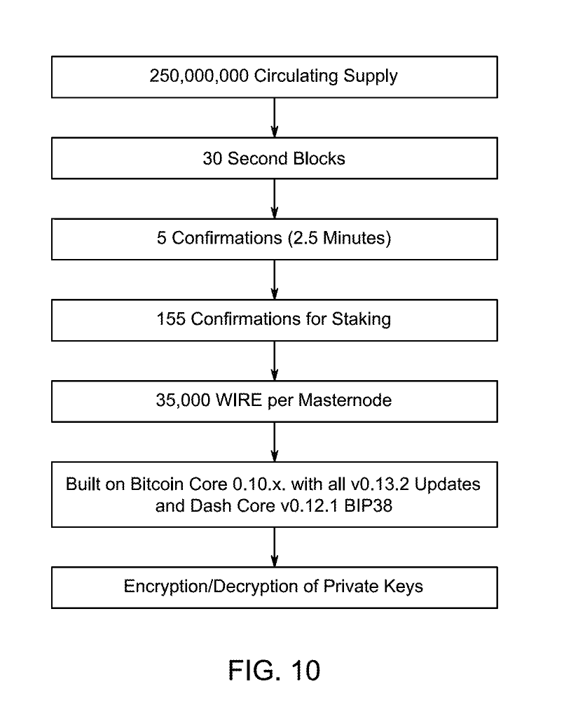

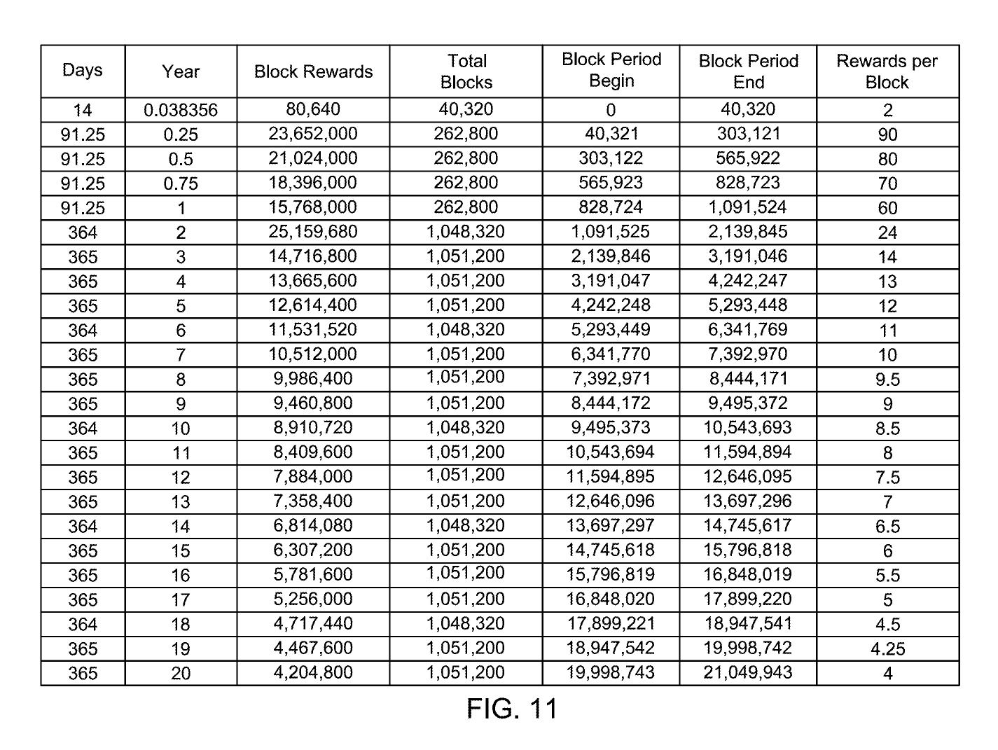

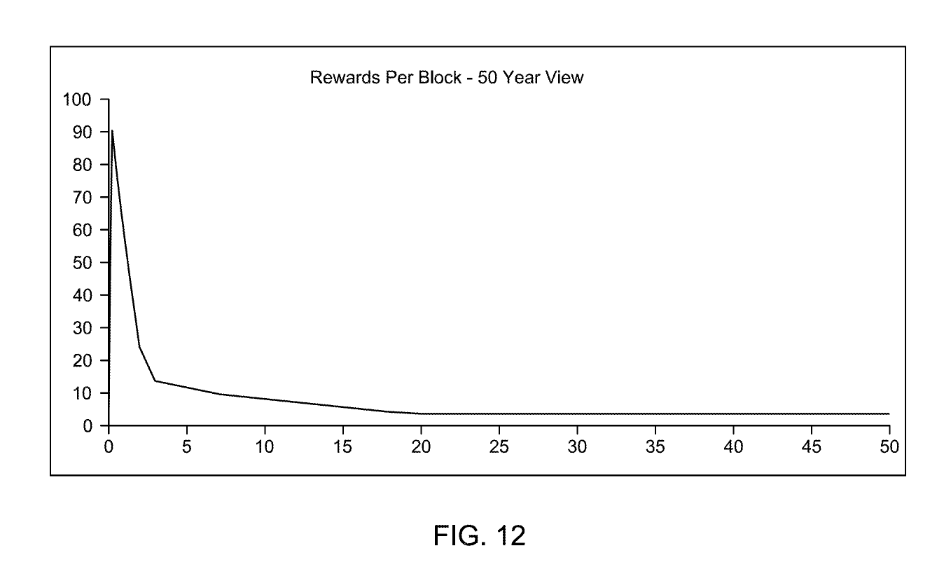

Wire cab use a variable Seesaw Reward Balance System that dynamically adjusts the block reward size between masternodes and staking nodes. The seesaw rewards feature can help maintain a balance between staking and mastemode use. Instant Sending Tokens are sent and confirmed in seconds, mainly due a network of decentralized masternodes. The network allows the transaction to occur without need for the normal 2.5-minute confirmation period. Masternodes and Staking Wire foster a decentralized and worldwide network by utilizing staking and masternode implementation. Wire holders can earn network rewards (token minting) by keeping their wallets open and staking or by using a fixed number of Wire (e.g., 35,000 Wire tokens) for collateral and creation of a masternode. The tokens used in Wire can exhibit the specifications shown in FIG. 10. FIG. 11 shows illustrative block rewards and FIG. 12 shows illustrative rewards per block over a 50 year cycle.

The Wire token is a utility token that can serve as “liquid” currency that facilitates operation of the zero knowledge blockchain platform according to embodiments discussed herein. Existence of Wire in an account in ZKBP can serve dual utility roles. In a first role, the platform requires Wire, in the form of a transaction fee, to facilitate the transmission process. In the other role, the Wire token is the cryptocurrency that will be sent to a recipient via a shared platform (e.g., email, text, or social media account). Once tokens are in the receiver's account, the receiver has a variety of options at his or her disposal. For example, the recipient can keep Wire in their wallet for future use. As another example, the recipient can make purchases utilizing a ZKBP sponsored debit card. In yet another example, the recipient can send Wire to friends, family, or colleagues using the ZKBP. Wire can be divided into any desired amount, for example, ranging from less than a penny or the full amount due. The ability to split, spend, or share Wire tokens are endless.

Non-native crypto-asset currencies that are registered with and included with the ZKBP may also be used in the same dual utility roles as the native currency. That is, for any transaction that uses a non-native crypto-asset, the ZKBP may keep a portion of the non-native asset as part of its transaction fee for using the platform and the remainder of the crypto-asset is transferred from the transferor user wallet to a transferee user wallet when the transferee accepts the transfer.

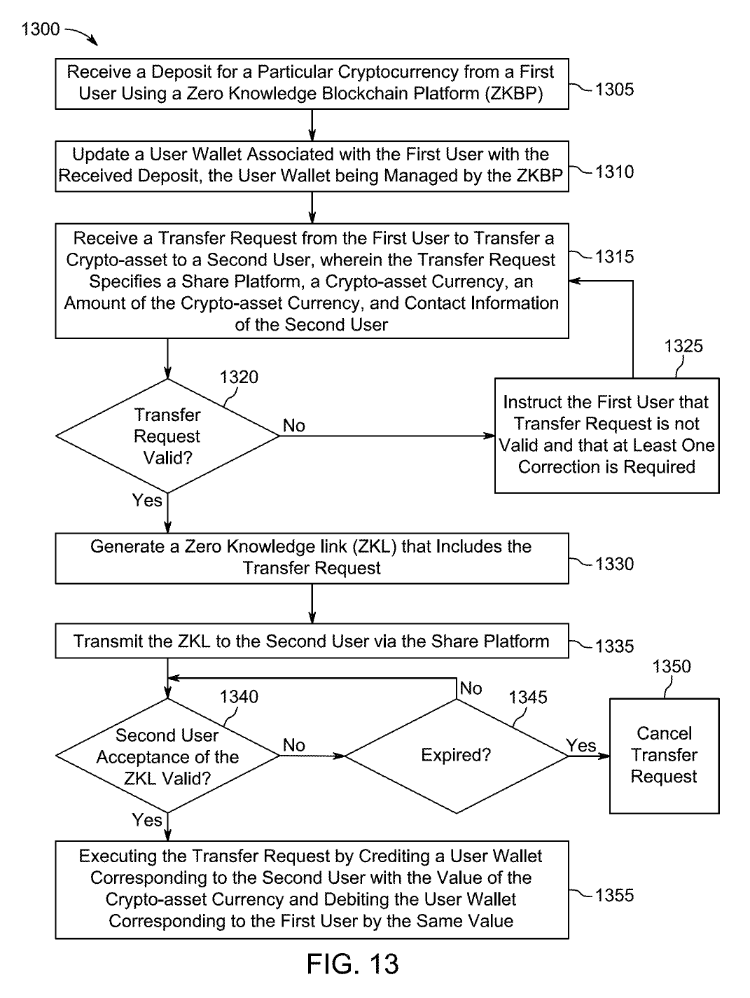

FIG. 13 shows illustrative process 1300 of first and second users interfacing with the ZKBP according to an embodiment. Starting with step 1305, a deposit for particular cryptocurrency can be received by a first user using the ZKBP. Crypto-asset manager 216 may process the deposit and wallet manager 214 may update the user wallet associated with the first user with received deposit, as indicated by step 1310. A transfer request may be received by the first user to transfer a crypto-asset to a second user, as step 1315. The transfer request may be entered by the first user by interacting with the user interface. As part of that interaction for creating the transfer request, the user may specify a share platform, a crypto-asset currency, an amount of the crypto-asset currency, and contact information of the second user. The ZKBP may determine whether the transfer request is valid at step 1320. For example, the ZKBP may determine whether the first user has sufficient funds to cover the value and a transfer fee. If the determination at step 1320 is NO, process 1325 may instruct the first user that the transfer request is not valid and that at least one correction is required.

If the determination at step 1320 is YES, process may generate a zero knowledge link (ZKL) that includes the transfer request. Zero knowledge link generator 217 may generate the ZKL, for example. The ZKL is transmitted to the second user via the selected share platform, at step 1335. For example, if the first user selected email as the share platform, the ZKL is emailed to the second user. At step 1340, the ZKBP can determine whether acceptance of the ZKL by the second user is valid. For example, the ZKBP can verify that the second user is the rightful recipient of the ZKL. If the determination at step 1340 is YES, the transfer request can be executed by crediting a user wallet corresponding to the second user with the value of the crypto-asset currency and debiting the user wallet corresponding to the first user by the same value, as indicated by step 1355. In addition, a transfer fee may be assessed to the first user, or in an alternative embodiment, the transfer fee may be split between the first and second users or the second user may be assessed the transfer fee.

If the determination ate step 1340 is NO, process 1300 may determine whether the ZKL has expired, as step 1345. If YES, the transfer request is cancelled at step 1350. If NO, process 1300 may loop back to step 1340.

It should be understood that the steps shown in FIG. 13 are merely illustrative and that additional steps may be added, that steps may be omitted, and the order of the steps may be rearranged.

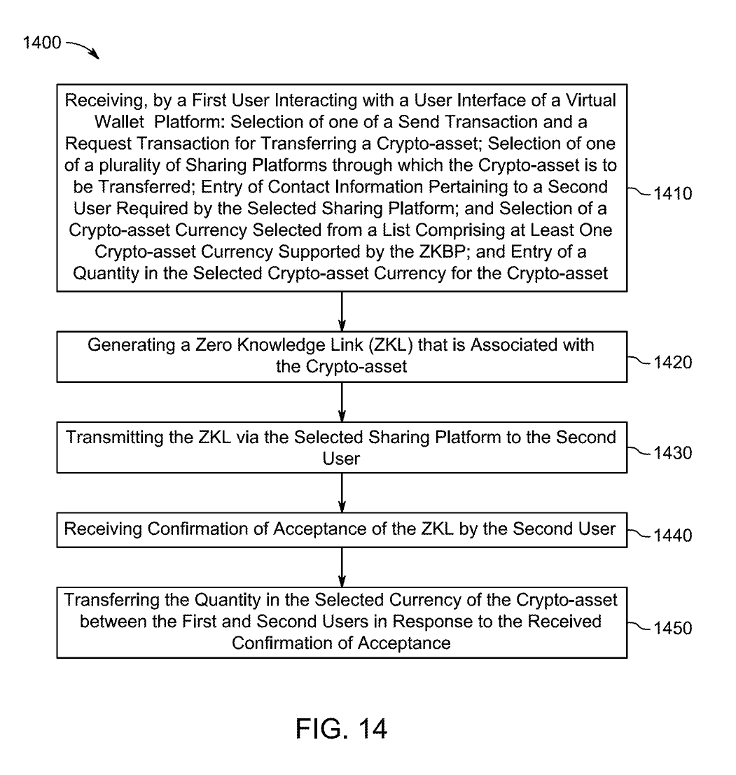

FIG. 14 shows an illustrative process 1400 for enabling a user send a crypto-asset to a user who has no knowledge the underlying crypto-asset being transmitted according to an embodiment. Process 1400 may be implemented in a ZKBP such as ZKBP 200. Starting at step 1410, the ZKBP can receive user inputs via a user interface of ZKBP. The user inputs can include selection of one of a send transaction and a request transaction for transferring a crypto-asset. For example, the user can select one of send button 321 and request button 322. The user can select one of a plurality of sharing platforms through which the crypto-asset is to be transferred. For example, the user can select one of the sharing platforms 330. The user can enter contact information pertaining to a second user required by the selected sharing platform, for example, by entering the contact information in contact field 340. The user can select a crypto-asset currency selected from a list including at least one crypto-asset currency supported by the ZKBP. The user can also enter a quantity in the selected crypto-asset currency for the crypto-asset.

At step 1420, ZKL that is associated with the crypto-asset is generated, and that ZKL is transmitted via the selected sharing platform to the second user, at step 1430. At step 1440, the ZKBP can receive confirmation of acceptance of the ZKL by the second user, and can transfer the quantity in the selected currency of the crypto-asset between the first and second users in response to the received confirmation of acceptance, at step 1450.

It should be understood that the steps shown in FIG. 14 are merely illustrative and that additional steps may be added, that steps may be omitted, and the order of the steps may be rearranged.

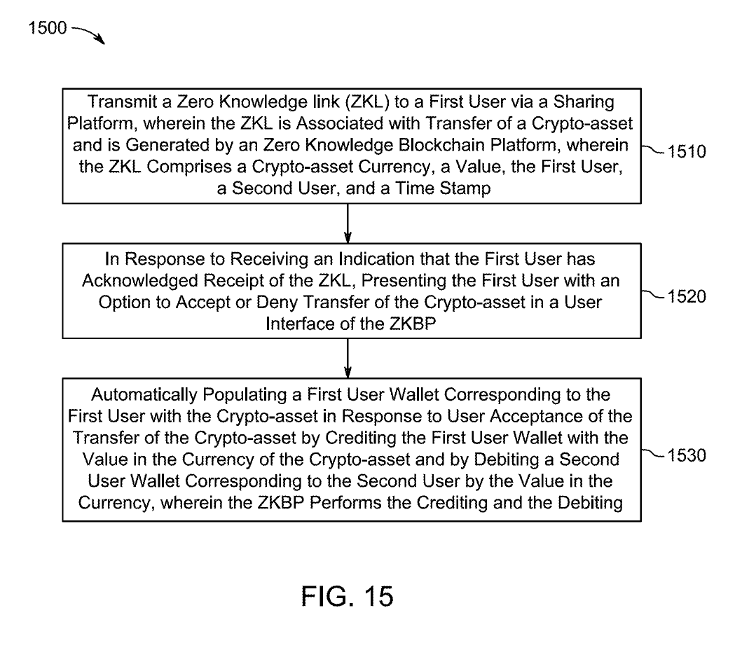

FIG. 15 shows an illustrative process 1500 for enabling a zero knowledge recipient of a crypto-asset to accept the crypto-asset being transmitted according to an embodiment. Process 1500 can transmit a ZKL to a first user via a sharing platform, wherein the ZKL is associated with transfer of a crypto-asset and is generated by a zero knowledge blockchain platform (ZKBP), wherein the ZKL includes a crypto-asset currency, a value, the first user, a second user, and a time stamp. At step 1520, in response to receiving an indication that the first user has acknowledged receipt of the ZKL, process 1500 can present the first user with an option to accept or deny transfer of the crypto-asset in a user interface of the ZKBP. At step, process 1500 can automatically populate a first user wallet corresponding to the first user with the crypto-asset in response to user acceptance of the transfer of the crypto-asset by crediting the first user wallet with the value in the currency of the crypto-asset and by debiting a second user wallet corresponding to the second user by the value in the currency, wherein the ZKBP performs the crediting and the debiting.

It should be understood that the steps shown in FIG. 15 are merely illustrative and that additional steps may be added, that steps may be omitted, and the order of the steps may be rearranged.

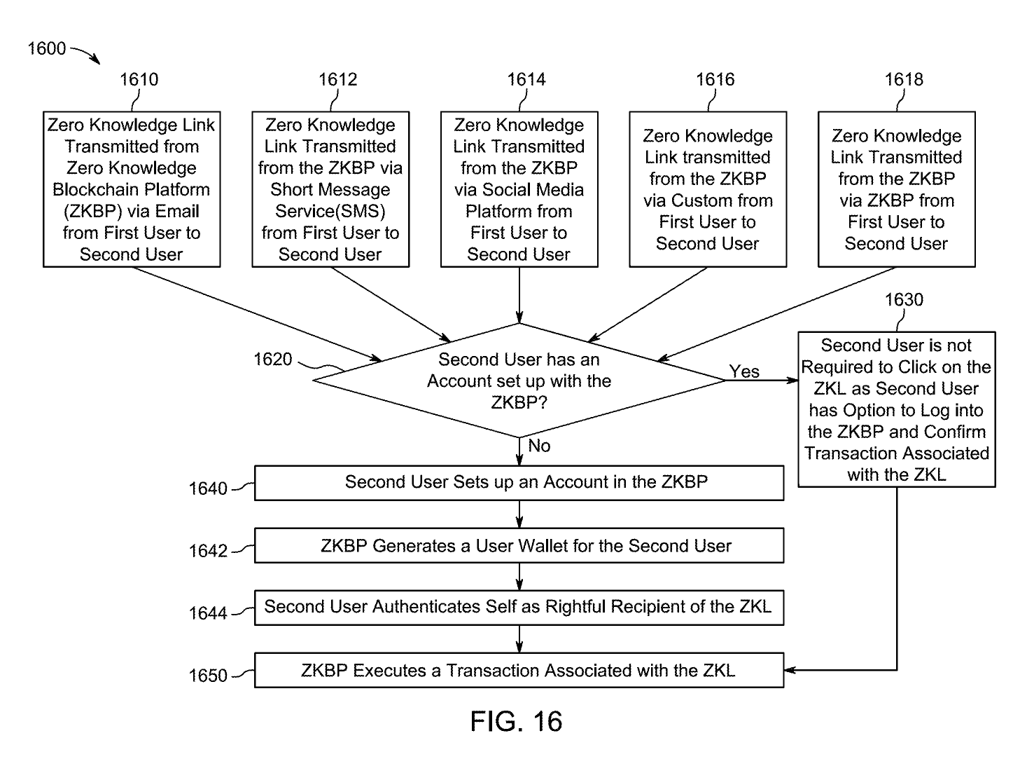

FIG. 16 shows illustrative process 1600 according to an embodiment. A zero knowledge link can be transmitted from a first user to a second user via email, short message service, a social media platform, custom format, and peer-to-peer within the ZKRP, as shown in steps 1610, 1612, 1614, 1616, and 1618, respectively. When the second user receives the ZKL via one of the shared platforms, the ZKBP can determine whether the second user already has an account set up. If the determination is YES, the second user is not required to click on the ZKL to confirm transaction associated with ZKL as the second user can log into his account on the ZKBP and confirm the transaction, as indicated at step 1630. When the second user confirms the transaction, the ZKBP can execute the transaction associated with the ZKL, at step 1650.

If the determination at step 1620 is NO, the second user sets up an account in the ZKBP, at step 1640 and the ZKBP generates a user wallet for the second user at step 1642. The second user is required to authenticate himself as rightful recipient of the ZKL. For example, if the user received the ZKL via email, the user may be required to sign up using the same email address used in the ZKL. As another example, if the user received the ZKL via the SMS platform, the user may be required to associate his or her phone number to the account. This association may also include inputting a two factor authentication code supplied to his phone. After the second user is authenticated, the ZKBP can execute the transaction associated with the ZKL.

It should be understood that the steps shown in FIG. 16 are merely illustrative and that additional steps may be added, that steps may be omitted, and the order of the steps may be rearranged.

It is believed that the disclosure set forth herein encompasses multiple distinct inventions with independent utility. While each of these inventions has been disclosed in its preferred form, the specific embodiments thereof as disclosed and illustrated herein are not to be considered in a limiting sense as numerous variations are possible. Each example defines an embodiment disclosed in the foregoing disclosure, but any one example does not necessarily encompass all features or combinations that may be eventually claimed. Where the description recites “a” or “a first” element or the equivalent thereof, such description includes one or more such elements, neither requiring nor excluding two or more such elements. Further, ordinal indicators, such as first, second or third, for identified elements are used to distinguish between the elements, and do not indicate a required or limited number of such elements, and do not indicate a particular position or order of such elements unless otherwise specifically stated.

Moreover, any processes described with respect to FIGS. 2-16, as well as any other aspects of the invention, may each be implemented by software, but may also be implemented in hardware, firmware, or any combination of software, hardware, and firmware. They each may also be embodied as machine- or computer-readable code recorded on a machine- or computer-readable medium. The computer-readable medium may be any data storage device that can store data or instructions which can thereafter be read by a computer system. Examples of the computer-readable medium may include, but are not limited to, read-only memory, random-access memory, flash memory, CD-ROMs, DVDs, magnetic tape, and optical data storage devices. The computer-readable medium can also be distributed over network-coupled computer systems so that the computer readable code is stored and executed in a distributed fashion. For example, the computer-readable medium may be communicated from one electronic subsystem or device to another electronic subsystem or device using any suitable communications protocol. The computer-readable medium may embody computer-readable code, instructions, data structures, program modules, or other data in a modulated data signal, such as a carrier wave or other transport mechanism, and may include any information delivery media. A modulated data signal may be a signal that has one or more of its characteristics set or changed in such a manner as to encode information in the signal.

It is to be understood that any or each module or state machine discussed herein may be provided as a software construct, firmware construct, one or more hardware components, or a combination thereof. For example, any one or more of the state machines or modules may be described in the general context of computer-executable instructions, such as program modules, that may be executed by one or more computers or other devices. Generally, a program module may include one or more routines, programs, objects, components, and/or data structures that may perform one or more particular tasks or that may implement one or more particular abstract data types. It is also to be understood that the number, configuration, functionality, and interconnection of the modules or state machines are merely illustrative, and that the number, configuration, functionality, and interconnection of existing modules may be modified or omitted, additional modules may be added, and the interconnection of certain modules may be altered.

Whereas many alterations and modifications of the present invention will no doubt become apparent to a person of ordinary skill in the art after having read the foregoing description, it is to be understood that the particular embodiments shown and described by way of illustration are in no way intended to be considered limiting. Therefore, reference to the details of the preferred embodiments is not intended to limit their scope.

1. A method, comprising:
receiving, by a first user interacting with a user interface of a zero knowledge blockchain platform (ZKBP):
selection of one of a send transaction and a request transaction for transferring a crypto-asset;
selection of one of a plurality of messaging platforms through which the crypto-asset is to be transferred;
entry of contact information pertaining to a second user required by the selected platform;
selection of a crypto-asset currency selected from a list comprising at least one crypto-asset currency supported by the ZKBP; and
entry of a quantity in the selected crypto-asset currency for the crypto-asset;
generating a zero knowledge link (ZKL) that is associated with the crypto-asset;
transmitting the ZKL via the selected messaging platform to the second user;
receiving confirmation of acceptance of the ZKL by the second user; and
transferring the quantity in the selected currency of the crypto-asset between the first and second users in response to the received confirmation of acceptance.

2. The method of claim 1, wherein generating the ZKL comprises modifying a transaction on a blockchain of the crypto-asset being transferred between the first and second users.

3. The method of claim 2, wherein the modifying the transaction on the blockchain comprises incorporating the quantity, a sending blockchain address, a receiving blockchain address, and a transaction identification.

4. The method of claim 2, wherein the modifying the transaction on the blockchain comprises incorporating the selected currency, the entered quantity, the first user, the second user, and a time stamp.

5. The method of claim 1, wherein the receiving confirmation comprises verifying that the second user has accessed the ZKBP using the ZKL and has accepted transfer of the crypto-asset using the ZKBP.

6. The method of claim 1, wherein the plurality of messaging platforms comprises email, short message service (SMS), and at least one social media platform.

7. The method of claim 1, wherein the plurality of messaging platforms comprises native messaging within the ZKBP.

8. The method of claim 1, wherein the at least one crypto-asset currency supported by the ZKBP comprises a blockchain that is managed by the ZKBP, wherein the ZKBP handles transferor to transferee blockchain transactions without requiring the transferor and the transferee to possess transferor and transferee addresses of the blockchain transaction.

9. The method of claim 1, wherein the list comprises a plurality of crypto-asset currencies supported by the ZKBP.

10. The method of claim 1, further comprising:
receiving a deposit corresponding to the at least one crypto-asset currency supported by the ZKBP.

11. The method of claim 9, further comprising managing the deposit in a user wallet on behalf of the first user.

12. The method of claim 1, wherein the receiving by the first user interacting with the user interface of the ZKBP further comprises entering a note associated with the crypto-asset.

13. A method, comprising:
transmitting a zero knowledge link (ZKL) to a first user via a sharing platform, wherein the ZKL is associated with transfer of a crypto-asset and is generated by a zero knowledge blockchain platform (ZKBP), wherein the ZKL comprises a crypto-asset currency, a value, the first user, a second user, and a time stamp;
in response to receiving an indication that the first user has acknowledged receipt of the ZKL, presenting the first user with an option to accept or deny transfer of the crypto-asset in a user interface of the ZKBP; and
automatically populating a first user wallet corresponding to the first user with the crypto-asset in response to user acceptance of the transfer of the crypto-asset by crediting the first user wallet with the value in the currency of the crypto-asset and by debiting a second user wallet corresponding to the second user by the value in the currency, wherein the ZKBP performs the crediting and the debiting.

14. The method of claim 13, wherein the ZKBP performs the crediting and debiting by processing blockchain alphanumeric sequences corresponding to the crypto-asset.

15. The method of claim 13, wherein the ZKL is generated in response to interaction with the ZKBP by the second user.

16. The method of claim 15, wherein the interaction with the ZKBP by the second user comprises:
selection of one of a send transaction and a request transaction for transferring the crypto-asset;
selection of the messaging platform from one of a plurality of sharing platforms through which the crypto-asset is to be transferred;
entry of contact information pertaining to the first user required by the selected sharing platform;
selection of the crypto-asset currency selected from a list comprising at least one crypto-asset currency supported by the ZKBP; and
entry of the value in the selected crypto-asset currency for the crypto-asset.

17. The method of claim 13, wherein the sharing platform is selected from the group consisting of email, short message service (SMS), and a social media platform.

18. The method of claim 13, wherein the sharing platform is a native message within the blockchain management platform.

19. The method of claim 13, wherein the ZKBP handles transferor to transferee blockchain transactions without requiring the transferor and the transferee to possess a transferor address and a transferee address of the blockchain transaction.

20. The method of claim 13, further comprising in response to receiving an indication that the first user has acknowledged receipt of the ZKL:
generating the first user wallet if the first user wallet has not been previously generated for the first user;
associating the crypto-asset with the first user wallet; and
displaying an accept transfer button and a reject transfer button in the first user wallet.

21. The method of claim 13, further comprising cancelling the ZKL in response to determining that the first user has not acknowledged receipt of the ZKL within a fixed period of time with respect to the time stamp.

22. The method of claim 13, further comprising returning the value of the cyptro-asset to the second user in response to user rejection of the transfer of the crypto-asset.

23. A method comprising:
receiving a crypto-asset transfer request from a first user, the crypto-asset transfer request comprising a social media platform, a recipient, and a value amount;
generating a zero knowledge link (ZKL) associated with the crypto-asset transfer request; transmitting the ZKL to the recipient via the social media platform;
receiving recipient acceptance of the ZKL; and
in response to the received recipient acceptance, crediting the recipient with the value amount and debiting the value amount from the first user without requiring the first user or the recipient to have knowledge of a blockchain address underlying the crypto-asset transfer request.
